(19) United States
(12) Patent Application Publication
(10) Pub. No.: US 2025/0192141 A1
(43) Pub. Date: Jun. 12, 2025

(54) Capillary Suspension-based Ink Formulations and Methods for Stable Graphite Anodes in Li-Ion Batteries

(71) Applicant: Board of Trustees of Western Michigan University, Kalamazoo, MI (US)

(72) Inventors: Massood Atashbar, Portage, MI (US); Valliammai Palaniappan, Kalamazoo, MI (US); Dinesh Maddipatla, Kalamazoo, MI (US)

(21) Appl. No.: 18/974,502

(22) Filed: Dec. 9, 2024

Related U.S. Application Data
(60) Provisional application No. 63/607,607, filed on Dec. 8, 2023.

(51) Int. Cl. H01M 4/1393; H01M 4/02; H01M 4/04; H01M 4/587; H01M 4/62; H01M 10/42

(52) U.S. Cl. CPC H01M 4/1393; H01M 4/0404; H01M 4/0435; H01M 4/587; H01M 4/622; H01M 4/625; H01M 10/4235; H01M 2004/027

(57) ABSTRACT

Aspects of the present disclosure include method for preparing a capillary-suspension based graphite anode, including dissolving an aqueous binder in water to form a gel; suspending a conductive additive and active material in said gel; and adding a short-chain immiscible hydrocarbon to the gel to improve the capacity at high currents and capacity retention in Li-Ion batteries using electrodes of the present disclosure.

### CROSS REFERENCE TO RELATED APPLICATIONS

The following application claims priority to U.S. Provisional Application No. 63/607,607, filed Dec. 8, 2023, which is incorporated by reference in its entirety.

### STATEMENT REGARDING FEDERALLY SPONSORED RESEARCH OR DEVELOPMENT

This invention was made with US Government support under Grant DE-EE0009111 awarded by the Department of Energy. The Government has certain rights in the invention

### TECHNICAL FIELD

The present disclosure relates to formulations and method to produce stable graphite anodes in lithium-ion batteries (LIB).

### BACKGROUND OF THE INVENTION

Lithium-ion batteries (LIB) must overcome key technical challenges such as reducing high production costs and improvement in battery pack energy density to increase the foothold of the electric vehicle (EV) market. The choice of electrode materials plays a crucial role in improving the energy density of LIBs and constitutes a major portion of the costs of LIBs. LIB energy density depends on gravimetric capacity density, rate capability, and cycle life. The gravimetric capacity density of electrodes, particularly anodes, have been significantly improved by employing different printing techniques, different anode materials that includes alloying-type, intercalation-type, and conversion-type host materials like mxenes, nickel, aluminum, red phosphorous, boron, graphene, and nitrogen.

The rate capability of anodes has been improved significantly over the years by intensively exploring and employing various nanostructured materials with tailored morphologies (e.g., nanoparticle networks, heterogeneous nano layers, and nano-porous and meso-porous architectures). Large surface areas and short diffusion lengths of such materials have shown to allow remarkable rate capability improvements.

However, performance parameters such as cycle life stability and capacity retention at higher current rates have remained unimproved over the years. Typically, electrodes consist of an active material, conductive additive, binders and solvent. In practice, to improve cycle life different binder technologies such as aqueous (water-based) and non-aqueous (organic) solvents are being employed in homogenous slurry preparations. Often, “ink slurries” are used that contain graphite and carbon black particles as both graphite and carbon black have high electronic conductivity, stability and long cycle life. The role of the binder is to hold the graphite and conductive additive together with the active material onto the current collector.

Generally, van der Waals forces play an important role in holding the active material together. In recent years, research is underway to develop binders with stronger bonding forces, providing additional adhesion strength by modifying the material chemistry of binder materials.

Improving the adhesion strength of conventional aqueous soluble binders has been less explored, however. FIG. 1(a)-(b) shows a model of the low-connectivity binder network formed in conventional anode ink slurry, (a) close up and (b) in a half-cell configuration. Capillary forces are a few magnitudes stronger than the van der Waals force, and to employ capillary forces, immiscibility must come into play when preparing ink slurries. Capillary force induced suspensions are three-phase fluids comprising a solid and two immiscible liquid phases. Addition of a small fraction of immiscible liquid (secondary solvent) to a suspension of particles dispersed in the primary solvent leads to the formation of a strong spanning particle network, even at low particle loadings, as shown in FIGS. 1(c)-(d), which show a model diagram of the improved binder network in capillary suspension type slurries, (c) close up and (d) in a half-cell configuration.

This particle network is formed due to the capillary forces inferred from the added secondary solvent. The strong capillary bridges are believed to improve the adhesion between active material and conductive additive, thereby reducing the volume expansion of graphite during charging and discharging. This improves the material composition and provides long cycling capability.

Here we use the capillary suspension concept to process graphite anodes to induce spanning network structure and to change the particle orientation from horizontal to vertical that results in improving the rate capability and capacity retention of LIBs. The use of the solvent octanol as the immiscible secondary octanol solvent allowed significant increases factors affecting in LIB battery performance such as rate performance and capacity retention are presented.

### BRIEF SUMMARY OF THE INVENTION

Some aspects of the present disclosure include a method for preparing a capillary-suspension

based graphite anode, comprising dissolving an aqueous binder in water to form a gel; suspending a conductive additive and active material in said gel; and adding a short-chain immiscible hydrocarbon to the gel.

In other aspects, the short-chain immiscible hydrocarbon is a short-chain immiscible alcohol. In yet others, the short-chain immiscible alcohol is selected from one or more of butanol, pentanol, hexanol, heptanol, octanol, nonanol, decanol, and isomers thereof. In others, the short-chain immiscible alcohol comprises octanol and/or isomers thereof. In some aspects, the solvent is 1-octanol. In general, immiscible solvents with a density similar to 1-octanol may be suitable (i.e., 0.827 g/ml), i.e., between 0.5 g/mL to 1.0 g/ml, 0.7 g/ml to 0.9 ml, about 0.8 g/ml.

In other aspects, said aqueous binder includes carboxymethyl cellulose (CMC). In others, the conductive additive includes carbon black. In others, the active material includes graphite. In others, the aqueous binder is substantially carboxymethyl cellulose (CMC). In others, the active material is substantially graphite. In yet others, the conductive additive is substantially carbon black.

In other aspects, adding a short-chain immiscible hydrocarbon to the gel occurs after said suspending a conductive additive and active material in said gel.

Other aspects include adding styrene-butadiene rubber (SBR) to said gel. Others include bar coating the gel onto a metal foil and drying said gel, and calendering said metal foil/gel. In other aspects, the ratio of active material: additive: SBR is 90:4:6.

In other aspects of the present disclosure, the anode upon drying has an increased vertical orientation as opposed to anodes prepared without said adding a short-chain immiscible hydrocarbon to the gel step. In others, said anode has about an 20-25% capacity improvement at high currents as opposed to anodes prepared without said adding a short-chain immiscible hydrocarbon to the gel step. In others, the anode has about an 5-11% improvement in capacity retention as opposed to anodes prepared without said adding a short-chain immiscible hydrocarbon to the gel step.

Embodiments of the present disclosure may include capillary-suspension based graphite anodes made with the properties listed herein, as well as the same produced using aspects of the present disclosure.

### BRIEF DESCRIPTION OF THE DRAWINGS

The present invention(s) are illustrated by way of example and not limitation with reference to the accompanying drawings, in which like references generally indicate similar elements or features.

FIG. 1 depicts models of (a)-(b) the binder structure of conventional anode ink slurries, and (c)-(d) the capillary suspension type slurry of the present disclosure;

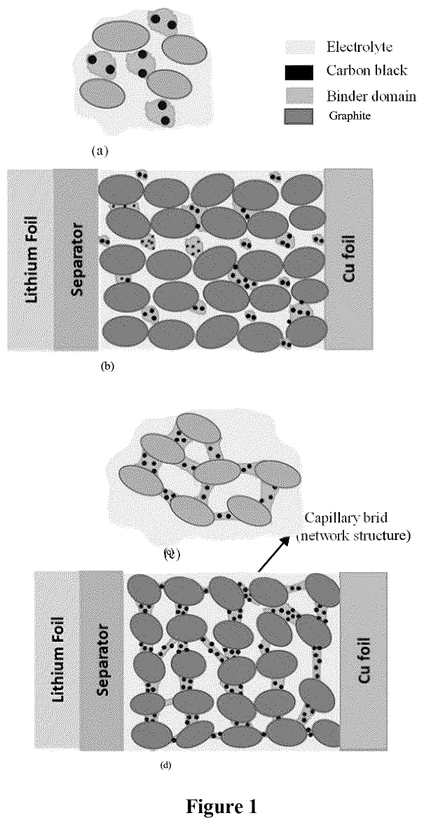

FIG. 2 is a diagram showing the slurry processing steps of Oct-0 and Oct-1 graphite electrode;

FIG. 3 depicts SEM characterizations showing the surface and cross-section view of Oct-0 (a-c), and Oct-1 electrodes (d-f);

FIG. 4 depicts a graph showing the rate performance of Oct-0 and Oct-1 graphite electrode;

FIG. 5 depicts a graph showing the capacity retention of Oct-0 and Oct-1 graphite electrode.

### DETAILED DESCRIPTION

Electrodes of the present invention may use graphite, graphite powder, or carbon black as the active material. Graphite may be from natural sources or synthesized, e.g., from petroleum feedstocks. Active materials may contain silicon alone or in combination with graphite.

Conductive additives help increase the surface area on the electrode available for electrode/electrolyte interactions. Super-P carbon black (C-45) (“ink”) is a common additive, along with conductive graphite (KS-6, KS-15, SFG-6, SFG-15, etc.), carbon fibers (VCGF), carbon nanotubes (CNT), graphene, and mixtures thereof. Other potential additives that may be used in embodiments of the present invention include SPUERLi, S-O, 350G, acetylene black (AB), Kezin black (KB), and vapor grown carbon fiber (VGCF).

Aqueous binders have been used in the industry as an alternative to organic (non-polar) binders such as PVDF dissolved in organic solvents such as NMP. PVDF has an advantage of forming viscous gels in the electrolyte, but causes safety and pollution problems during use and manufacture. Suitable aqueous binders may also comprise styrene-butadiene rubber (SBR)-based and modified SBR-based materials. Carboxylmethyl cellulose (CMC) may serve as a low-cost, stable thickening agent with SBR. This combination affords cost, safety and performance advantages over non-polar systems, in cells involving graphite, metal-based, sulfur and silicon-based electrodes. Other cellulose-based gelling agents and CMC variants (with chains of various lengths and branching) may be used in embodiment and aspects of the present disclosure.

Immiscible secondary solvents may include octanol or similar small-chain, immiscible organic alcohols, such as various isomers of octanol alone or in combination, butanol, pentanol, hexanol, heptanol, nonanol, etc., as well isomers thereof and combinations thereof, to form improved secondary structuring of the electrode material upon mixing, processing, coating and drying. In some aspects, the solvent is 1-octanol. In general, immiscible solvents with a density similar to 1-octanol may be suitable (i.e., 0.827 g/ml), i.e., between 0.5 g/mL to 1.0 g/ml, 0.7 g/ml to 0.9 ml, about 0.8 g/ml.

The above ingredients are mixed to form a uniform slurry, with the addition of the secondary solvent thought to give an improved morphology to the binder phase. The slurry is then normally coated on metal foil (often copper as the anode, although other suitable metals may be used) as a current collector, and then dried to adhere the electrode components to the foil. Parameters of the drying phases to dry out the slurry and drive off solvents can also be adjusted in aspects and embodiments of the present invention to affect structure.

Calendaring (rolling) of the dried electrode can create a uniform thickness of the electrode and affect the pore structure and resultant performance of the electrode.

### EXAMPLE 1

A conventional aqueous anode slurry was prepared using commercially available plate-shaped, synthetic graphite powder (particle size: 5 μm) as active material, with Super-P carbon black (C-45) used as conductive additive, carboxymethyl cellulose (CMC) as aqueous binder along with styrene-butadiene rubber (SBR). The ratio of wt. % of materials used is 90:4:6 for graphite, carbon black (CB) and CMC/SBR respectively. The solid content of the ink was adjusted to 30 wt. % in 70 wt. % water solvent.

To obtain a homogenous ink slurry, the CMC was dissolved in distilled water (3 wt %, CMC-H2O mixture) and magnetically stirred for 3 hours at 1200 rpm. Carbon black (4 wt %) was dispersed in a homogenous CMC-water solution for 2000 rpm for 6 minutes followed by adding graphite (90 wt %) and mixing it at 1000 rpm for 10 minutes using a Thinky AR-100 mixer. To ensure particle de-agglomeration and slurry homogeneity, water was added stepwise during the mixing procedure until it reached a solid content of 30%. SBR addition was performed as a final step for the conventional slurry, via a rotation speed of 500 rpm for 10 minutes. This conventional slurry with no secondary solvent is referred as “Oct-0” herein and in the Figures described more fully below.

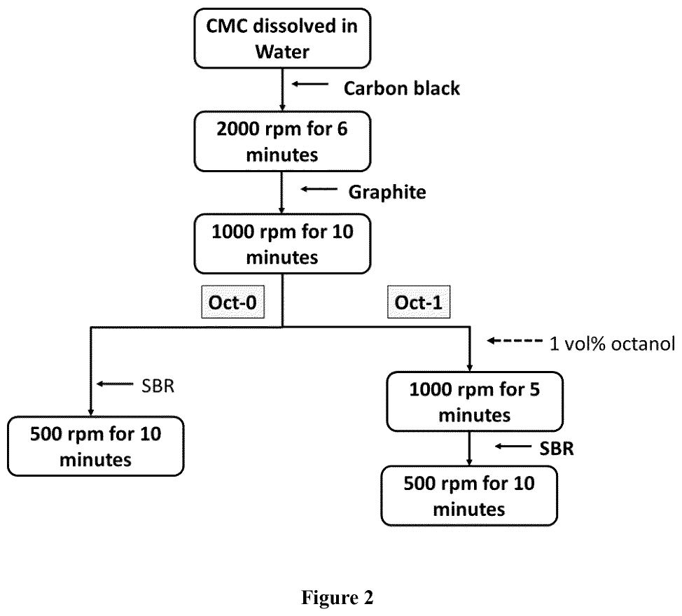

In order to prepare a capillary suspension-based slurry of the present disclosure, 1 vol % octanol was added before the addition of SBR, and the rotation speed was controlled at 1000 rpm for 5 minutes followed by the addition of SBR at 500 rpm for 10 minutes (FIG. 2). This capillary suspension-based slurry with 1 vol % octanol is referred as Oct-1.

The as-prepared conventional slurry and capillary suspension-based slurry were bar-coated on copper foil. Subsequently the Oct-0 and Oct-1 coated electrodes were dried at 60° C. for 6 hours in a VWR® oven and vacuum-cured in an Across International oven at 80° C. for 10 hours to completely remove any residual solvent.

Compaction via calendering was performed to control the porosity of both electrodes at ˜35%.

### EXAMPLE 2

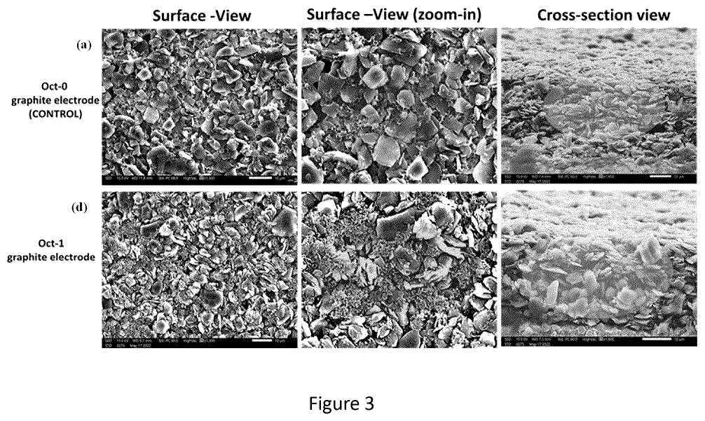

The surface view and cross-section view of the electrodes produced in Example 1 were studied using a Joel® JSM-IT200 scanning electron microscope as shown in FIG. 3 for the Oct-0 [FIG. 3(a)-(c)] and Oct-1 [FIG. 3(d)-(f)] electrodes. The influence of immiscible secondary octanol solvent in the microstructure formation and particle orientation is shown in cross-section view in FIG. 3(f). The microstructure of the Oct-1 electrodes reveals a slight change in orientation, i.e., the graphite particles (highlighted in yellow) are more vertically oriented to current collector surface compared to the Oct-0 electrode in FIG. 3(c). This may be due to the involvement of capillary forces forming capillary bridges like carbon binder domain (spanning network structures) in FIG. 3(e) (highlighted in red), thus resulting in less tortuous ion transport pathways enhancing rate capability and capacity retention. Whereas, in the Oct-0 control electrode, the particle orientation is more parallel to current collector surface, the carbon binder domain is highly distorted, and no network like structures were visible (FIG. 3(b))

### EXAMPLE 3

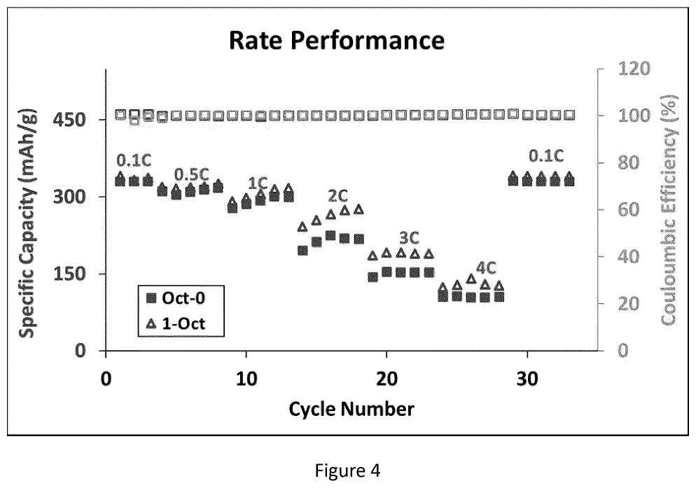

The electrochemical performance of the fabricated Oct-0 and Oct-1 graphite electrodes was obtained by assembling half-cell LIB. Coin-cells (14 mm diameter) were punched out of the Oct-0 and Oct-1 graphite electrodes and used as the cathode, and lithium foil was used as anode in a half-cell configuration (in a full cell, graphite electrodes of the present disclosure would normally be the anode). LiPF₆ was used as the electrolyte, and polypropylene/polyethylene/polypropylene (PP/PE/PP) was used as a separator. Electrochemical characterization was performed on both the half cells at constant current rates ranging from 0.1 mA to 4 mA and was recovered back to 0.1 mA at the end of test using CT3002AU battery tester from LAND instruments. FIG. 4 shows the rate performance of the assembled cells for five cycles at each current rate from 0.1 C to 4 C and recovered back to 0.1 C.

Initial specific capacities of 330 and 340 mAh/g were measured for Oct-0 and Oct-1 based cells, respectively at 0.1 C.Similarly, specific capacities of 310 and 315 mAh/g, 290 and 300 mAh/g was measured for Oct-0 and Oct-1 cells at 0.5 C and 1 C, respectively. At high C-rates of 2 C, 3 C and 4 C, specific capacities of Oct-0 were 214, 150, and 104 mAh/g, respectively, and for Oct-1 were 262, 189, and 130 mAh/g, respectively.

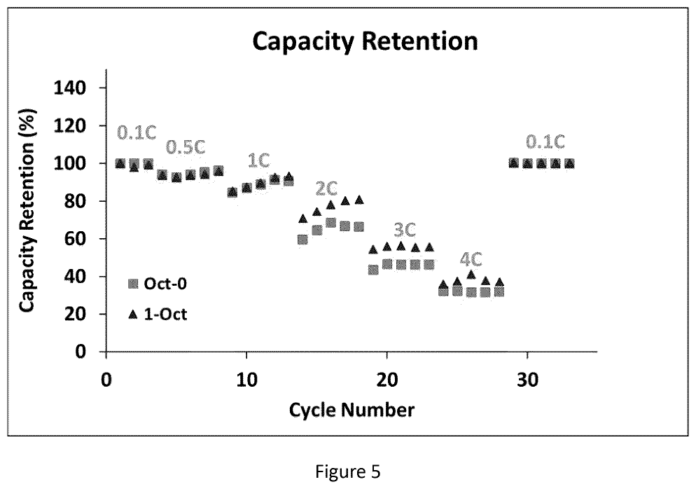

This resulted in a significant improvement of 22%, 25% and 23% in the capacities of Oct-1 graphite electrodes when compared to Oct-0 electrodes at higher currents of 2 C, 3 C and 4 C, respectively. Similarly, capacity retention was significantly improved: 76%, 55%, and 37% for Oct-1 graphite electrodes when compared to Oct-0 electrodes with 65%, 45% and 32% capacity retention at 2 C, 3 C and 4 C, respectively (FIG. 5).

This improvement in capacities and retention at high C-rates can be attributed to the vertical orientation and bridge-like structures of carbon-binder domain that is holding the graphite active material intact. After testing at 4 C current rate, the cells were recovered back to 0.1 C.

In summary, a conventional (Oct-0) and capillary suspension-based graphite anode (Oct-1) was successfully developed with an average thickness of 34 μm and a mass-loading of ˜2 mg/cm² and porosity of ˜35%. SEM analyses were performed for the fabricated cells, which revealed a change in orientation of graphite particles after the addition of immiscible secondary solvent (1 vol % octanol). The Oct-1 graphite electrodes showed a significant improvement of 22%, 25% and 23% in the capacities of Oct-1 graphite electrodes when compared to Oct-0 graphite electrodes at higher currents of 2 C, 3 C and 4 C respectively. The Oct-1 graphite electrode also showed a higher capacity retention of 76%, 55%, and 37% when compared to Oct-0 graphite electrodes with retention of 65%, 45% and 32% at 2 C, 3 C and 4 C, respectively.

What is claimed is:

1. A method for preparing a capillary-suspension based graphite anode, comprising
dissolving an aqueous binder in water to form a gel;
suspending a conductive additive and active material in said gel;
adding a short-chain immiscible hydrocarbon to the gel.

2. The method of claim 1, wherein the short-chain immiscible hydrocarbon is a short-chain immiscible alcohol.

3. The method of claim 2, wherein the short-chain immiscible alcohol is selected from one or more of butanol, pentanol, hexanol, heptanol, octanol, nonanol, decanol, and isomers thereof.

4. The method of claim 3, wherein the short-chain immiscible alcohol comprises octanol and/or isomers thereof.

5. The method of claim 4, wherein is isomer of octanol is 1-octanol.

6. The method of claim 1, wherein the immiscible hydrocarbon has a density between 0.5 g/mL to 1.0 g/ml, 0.7 g/ml to 0.9 ml, about 0.8 g/ml

7. The method of claim 1, wherein said aqueous binder comprises carboxymethyl cellulose (CMC).

8. The method of claim 1, wherein the conductive additive comprises carbon black.

9. The method of claim 1, wherein the active material comprises graphite.

10. The method of claim 1, wherein said aqueous binder consists of carboxymethyl cellulose (CMC).

11. The method of claim 1, wherein the conductive additive consists of carbon black.

12. The method of claim 1, wherein the active material consists of graphite.

13. The method of claim 1, wherein said adding a short-chain immiscible hydrocarbon to the gel occurs after said suspending a conductive additive and active material in said gel.

14. The method of claim 1, further comprising adding styrene-butadiene rubber (SBR) to said gel.

15. The method of claim 1, further comprising bar coating the gel onto metal foil and drying said gel, calendering said metal foil/gel.

16. The method of claim 12, wherein the ratio of active material: additive: SBR is 90:4:6.

17. The method of claim 13, wherein said anode upon drying has an increased vertical orientation as opposed to anodes prepared without said adding a short-chain immiscible hydrocarbon to the gel step.

18. The method of claim 1, wherein said anode has about an 20-25% capacity improvement at high currents as opposed to anodes prepared without said adding a short-chain immiscible hydrocarbon to the gel step.

19. The method of claim 1, wherein said anode has about an 5-11% improvement in capacity retention as opposed to anodes prepared without said adding a short-chain immiscible hydrocarbon to the gel step.
